(19) United States
(12) Patent Application Publication
(10) Pub. No.: US 2004/0090120 A1
(43) Pub. Date: May 13, 2004

(54) Multiplex power distribution system with a power-saving circuit for a vehicle

(76) Inventors: Lauri Lamberg, (US); Asko Juntunen, Oulu (FI)

Correspondence Address: Davidson Davidson & Kappel, 485 Seventh Avenue 14th Floor, New York, NY, 10018, US

(21) Appl. No.: 10/312,165

(22) PCT Filed: Jun. 27, 2001
(86) PCT No.: PCT/FI01/00611

(30) Foreign Application Priority Data
Jun. 29, 2000 (FI) 2001538

(51) Int. Cl. B60L 3/00; H02G 3/00; B60L 1/00

(52) U.S. Cl. 307/9.1

(57) ABSTRACT

The present invention relates to a vehicle's multiplex power distribution system with a power-saving circuit. The system has in one or more cable branches (2) a plurality of intelligent nodes (3) with controlled outputs for feeding consumers in a controlled manner. Power to the control electronics (6, 7) is passed via a power-saving circuit (10) including a controlled solid-state switch (M1) with a diode (D3) which is connected in series with the same and is maintained reverse-biased by a capacitor (C3). The control circuit (R1, R2, M2) of the solid-state switch (M1) includes a second solid-state switch (M2) that receives its control voltage on one hand from the microprocessor (7) of the control electronics (6, 7) via a diode (D2) and on the other hand from an awakening circuit (C1, C2, D1, R3, R4) connected between the diode (D2) and the second solid-state switch (M2), whereby the voltage of the awakening circuit goes high at the rising edge of said short-duration interruption of the supply voltage (Vpp) thus driving the second solid-state switch (M2) conductive, whereupon also the actual power-supplying solid-state switch (M1) is driven conductive.

The present invention relates to a vehicle's multiplex power distribution system with a power-saving circuit comprising

a cable with conductors for power supply and a data bus,

a plurality of intelligent nodes connected to power-supply conductors and data bus conductors of the cable,

controlled outputs of said intelligent nodes for supplying power in a controlled manner to consumers,

control electronics for the control of solid-state power switches,

a power-saving circuit capable of setting the control electronics into an Asleep mode and setting the same back to a power-switching Awake mode by a control signal.

This kind of a system is known from U.S. Pat. No. 5,670,845. The system disclosed in this publication needs a separate data signal for setting the Awake mode. While cited publication does not specify the construction and function of the circuit issuing the activate signal, it is plausible that a conventional technique is used for setting the control electronics into a low-power Aware mode, wherein the control electronics is not entirely disconnected from the power supply line but is able to receive an activate signal, thereby assuming an Aware mode having all inputs and outputs in full functionality. Such a low-power Aware mode also consumes power. However, the number of electronic devices in vehicles tends to grow. Resultingly, the overall power consumption increases. Even when the vehicle is not used (with the central locking system activated), the system has an unnecessarily large number in the Aware mode consuming power.

If a vehicle such as car has to stay unused for a longer time, the battery charge will eventually become exhausted, whereby actuators such as central locking cease to function and the car cannot be started.

Moreover, running electronic equipment constantly powered also causes a shorter life of the electronic circuitry.

It is an object of the invention to provide a technique by means of which the control electronics of the intelligent nodes in the system of the above-described kind can be forced into a completely zero-power Asleep mode and then again evoked into fully functional Active mode.

The goal of the invention is achieved by way of the features specified in appended claim 1.

Details of a preferred embodiment of the invention are disclosed in the dependent claims.

In the following, the invention will be examined in greater detail with the help of an exemplifying embodiment by making reference to the appended drawings in which

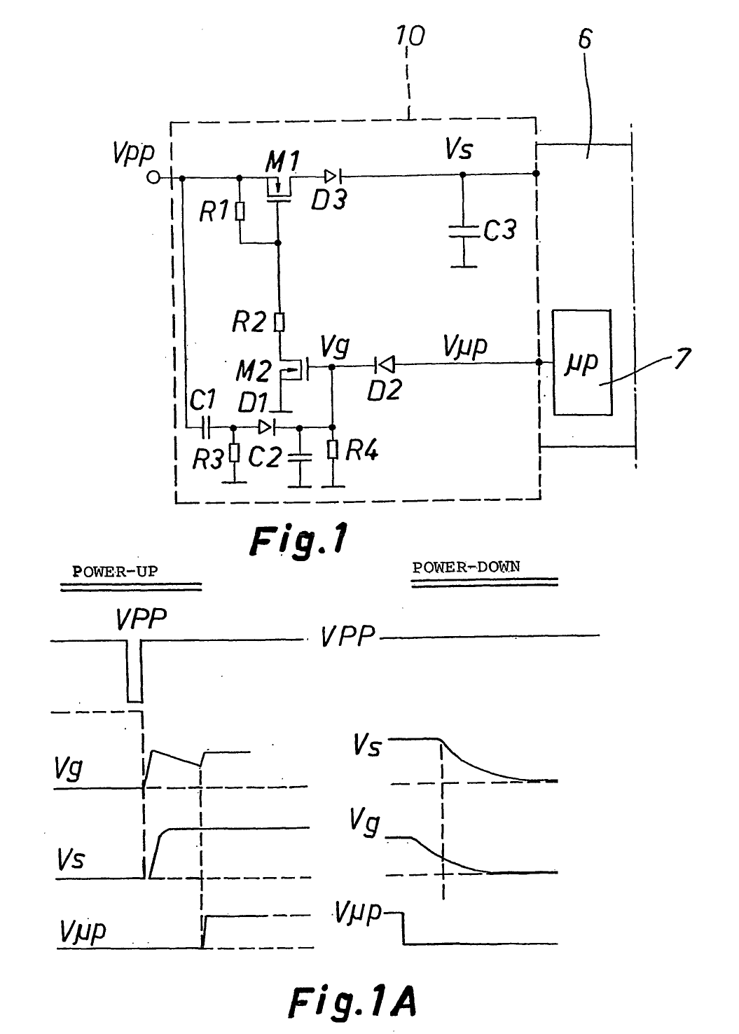

FIG. 1 shows a power-saving circuit according to the invention for use in a multiplex power distribution system of a vehicle;

FIG. 1A shows a plot of voltage waveshapes at different points of the power-saving circuit during start-up (into the Awake mode) and shut-down;

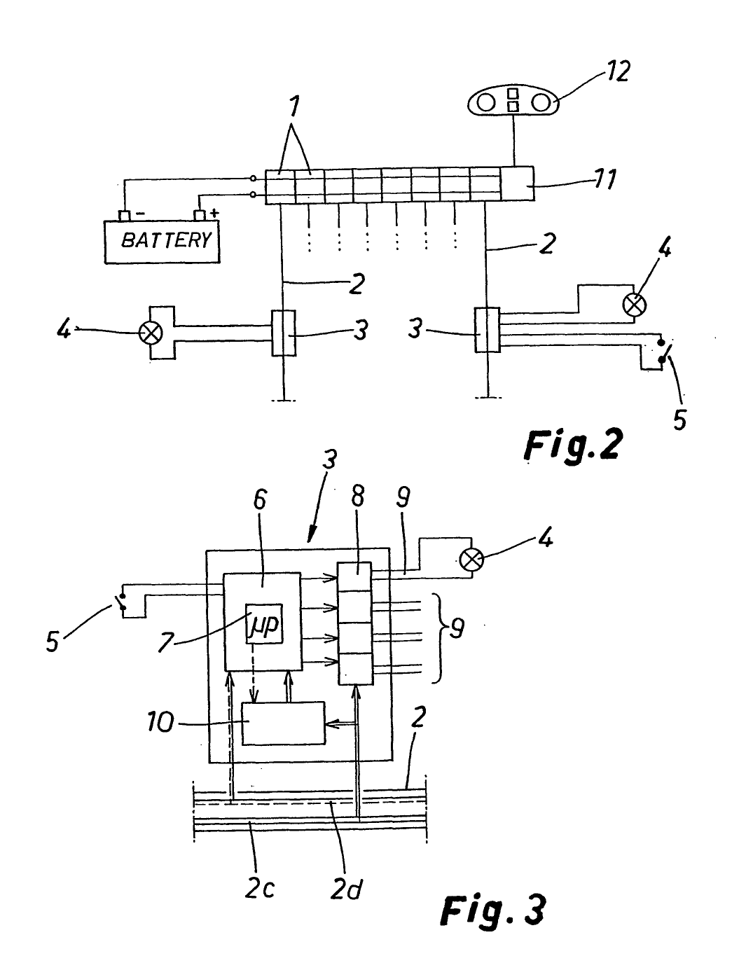

FIG. 2 shows an overall circuit diagram of a power distribution system; and

FIG. 3 shows a block diagram of an individual intelligent node in a multiplex power distribution system.

Prior to describing the power-saving circuit shown in FIG. 1, the structure and function of a power distribution system is outlined by making reference to FIGS. 2 and 3.

In the illustrated layout, power is fed from a battery to cable branches 2 via connection modules 1. Each one of the cable branches 2 has an individual connection module 1 incorporating a solid-state switch (not shown) for controlling the output current. As can be seen from FIG. 3, each cable 2 comprises current feed conductors 2c and data path conductors 2d. The system may also be implemented without separate data path conductors, whereby data transmission and current feed is arranged to take place over common conductors. A plurality of intelligent nodes 3 are connected to the current feed conductors 2c and data path conductors 2d of the cable 2. One cable branch 2 may have one or more intelligent nodes 3 connected thereto. The intelligent nodes 3 are provided with controlled outputs 9 for steering power to consumers 4. The intelligent nodes 3 may also have control inputs for connecting control switches 5 to the control electronics 6, 7 of the intelligent nodes.

The intelligent nodes 3 communicate with each other over a common data path 2d. Also the data paths of the cable branches 2 are routed via the connection modules 1 and, additionally, communicate with an adapter 11 serving multiple functions. The adapter 11 controls a display 12 on the basis of state information received from node 3. Via the adapter 1 the nodes 3 can be updated with configuration information individually for each one of the nodes 3, whereby the same information may also be stored into the adapter 11 for later needs that may occur, e.g., when a defective node is replaced by a new node 3.

Power to outputs 9 is supplied via controlled solid-state power switches 8. This control function is taken care of by control electronics 6, 7 containing a microprocessor 7 with a memory and an ASIC chip required for interfacing the microprocessor 7 with its peripheral circuitry. The solid-state power switches 8 that may be FETs for instance, can stay connected to the supply voltage also during the zero-power Asleep mode inasmuch the switches 8 are not controlled conductive, whereby no current can flow through them.

The control electronics 6, 7 receives its supply voltage via the power-saving circuit 10 that serves to put the control electronics 6, 7 into a complete zero-power Asleep mode and again to restore the power-supplying active mode thereof by means of an Awake signal. In system based on serial data transmission, a control signal is issued to those nodes 3 that are desired to be set in a zero-power Asleep mode. The node may also be allowed to make a self-contained decision on the basis of given conditions to assume the Asleep mode. Different nodes can react in different ways on the control signals. For instance, when the ignition key is turned to switch off power from the system, all or at least a majority of the nodes are put in the zero-power Asleep mode.

Each one of the nodes 3 has a separate solid-state switch M1 (see FIG. 1) that controls power feed to the node's control electronics. After receiving a control signal that sets a node into the zero-power Asleep mode, the node stores the controlled state in its memory and shuts itself off from the power feed by virtue of the zero-power circuitry shown in FIG. 1. The node may also assume the zero-power Asleep mode in a self-contained manner without receiving a specific control signal. In the latter case, the node sends the system a message “zero-power mode assumed” so that the node may be later awakened. Obviously, a plurality of different awakening methods and conditions are conceivable. For instance, release of the central locking of doors always triggers the issuance of an Awake control signal. The Awake control signal may be issued to all the cable branches of the system simultaneously or, alternatively, it may be directed specifically to one or more cable branches containing nodes to be awakened.

When nodes are to be awakened, that is to be put off from the Asleep mode, the nodes residing in the Aware mode are sent a control signal that turns off any outputs 9 possibly delivering power to consumers. This step is not absolutely mandatory, but it gives the advantage that the power switch sending the awakening control signal need not disconnect and switch on so high a current that would be necessary without first carrying out this step. The power supply unit comprised of the connection modules 1 turns off for a short time (a few milliseconds) the supply voltage, whereby the circuit shown in FIG. 1 of the zero-powered nodes 3 controls the supply-voltage switch M1 conductive on the rising edge of the switched-on supply voltage and thus keeps the supply-voltage control active until the node control electronics 6, 7 has performed the awakening initiation steps and the microprocessor or microcontroller 7 of the node has completed the power-up procedures of the node.

In the following is described in more detail the structure and function of the circuit shown in FIG. 1. In a normal situation, the solid-state switch M1 (a PMOS or PNP transistor) is conductive inasmuch the solid-state switch M2 (an NMOS or NPN transistor) is conductive as its gate voltage Vg is high. The microprocessor or microcontroller 7 keeps the gate voltage Vg high by driving the gate/base of the switch M2 via diode D2 high.

When processor 7 receives over the vehicle bus 2d a message to assume the zero-power mode or the processor 7 itself identifies the situation appropriate for the zero-power mode, the processor 7 cuts off drive voltage/current passed via diode D2 to the gate of switch M2. The voltage at the gate of the switch falls as determined by the time constant R4·C2. When the voltage falls below the cut-off threshold of M2, gradual turn-off of the switch M2 starts thus cutting off the current flowing therethrough. This in turn causes the gate control voltage Vg of M1 to fall, whereby switch M1 turns off. As the current to capacitor C3 is thence switched off, the voltage over the capacitor begins to approach zero and the electronics circuit 6, 7 powered therefrom is disconnected from the supply voltage and current.

When the system wishes to awaken a node, it takes the supply voltage Vpp down for a short time. This can be implemented, e.g., by controlling the solid-state switches of each connection module 1 through which the power to the cable branches 2 takes place. Each node has capacitor C3 and a diode D3 reverse-biased by the capacitor voltage, whereby the supply voltage over the capacitor C3 of any one of the Awake-mode nodes stays sufficiently high during power cut-off required for awakening the Asleep-mode nodes. During the rising edge of the awakening signal, the voltage supplied to the Vg point of M2 rises the voltage over capacitor C2 via capacitor C1 and diode D1. At a sufficiently high voltage at Vg, M2 becomes conductive, whereby M1 is biased via resistors R2 and R1 and becomes conductive thus beginning to charge capacitor C3 via diode D3. With rising voltage over capacitor C3, the control electronics 6, 7 becomes operative. Time constant R4·C2 is made so long that capacitor C3 can be fully charged during start-up thus permitting the control electronics 6, 7 to become operative. After the start-up of control electronics 6, 7, the circuit can maintain a steady power-up signal via diode D2 to the gate of M2 thus keeping M2 as well as M1 continuously conductive.

The method according to the invention is suited for use in power distribution systems operating at different supply voltage levels (e.g., 12 V, 24 V or 42 V).

What is claimed is:

1. A vehicle's multiplex power distribution system with a power-saving circuit comprising
a cable (2) with conductors (2c, 2d) for power supply and a data bus,
a plurality of intelligent nodes (3) connected to said power-supply conductors (2c) and said data bus conductors (2d) of said cable (2),
controlled outputs (9) of said intelligent nodes (3) for supplying power in a controlled manner to consumers (4),
control electronics (6, 7) for the control of solid-state power switches (8), and
a power-saving circuit (10) capable of setting said control electronics (6, 7) into an Asleep mode and setting the same back to a power-switching Awake mode by a control signal,
characterized in that
said control electronics (6, 7) receives its supply voltage via a controlled solid-state switch (M1) and a diode (D3) connected in series with the same, both components being an integral part of said power-saving circuit (10),
the control circuit (R1, R2, M2) of said solid-state switch (M1) is arranged to receive its control signal from a microprocessor (7) of said control electronics (6, 7), whereby said control signal is capable of driving said solid-state switch (M1) conductive for supplying power and, respectively, into a cut-off state to effect a zero-power Asleep mode function,
the control circuit (R1, R2, M2) of said solid-state switch (M1) is arranged to detect its Awake mode control signal from a short-duration change in the supply voltage (Vpp), and
after said diode (D3) over the power supply line there is connected a capacitor (C3) serving to keep the power supply line high during said short-duration awakening control signal in order to assure uninterrupted power feed to those ones of said intelligent nodes (3) that are already active in an Awake mode.

2. System according to claim 1, characterized in that said Awake mode control signal is a short-duration interruption in the supply voltage (Vpp).

3. System according to claim 2, characterized in that, prior to the issuance of said Awake mode control signal, onto the data bus (2d) of the system is issued a message causing said intelligent nodes (3) that are already active in an Awake mode to effect a short-duration cut-off of their power outputs (9).

4. System according to any one of foregoing claims 1-3, characterized in that said control circuit (R1, R2, M2) of said solid-state switch (M1) includes a second solid-state switch (M2) that receives its control signal on one hand from said microprocessor of said control electronics (6, 7) via a diode (D2) and on the other hand from an awakening circuit (C1, C2, D1, R3, R4) connected between said diode (D2) and said second solid-state switch (M2), whereby the voltage of said awakening circuit goes high at the rising edge of said short-duration interruption of the supply voltage (Vpp) thus driving said second solid-state switch (M2) conductive.

5. System according to claim 4, characterized in that said awakening circuit (C1, C2, D1, R3, R4) comprises the series connection of a capacitor (C1) connected to the power supply voltage (Vpp) with a diode (D1), to which is further connected after said diode (D1) a capacitor (C2) in parallel with a resistor (R4), whereby said second solid-state switch (M2) receives its awakening control voltage (Vg) from the common point between said diode (D1) and said parallel connection (C2, R4).
